(19) United States
(12) Patent Application Publication
(10) Pub. No.: US 2009/0242328 A1
(43) Pub. Date: Oct. 1, 2009

(54) STABILIZING MECHANISM FOR RIGID FIXED AND EXTENSION LADDERS

(76) Inventors: Pedro Cabrera, Miami, FL (US); Jose A. Suarez, Miami, FL (US); Ruben Guinovart, Miami, FL (US)

Correspondence Address: SANCHELIMA & ASSOCIATES, P.A.;JESUS SANCHELIMA, ESQ., 235 S.W. LE JEUNE ROAD, MIAMI, FL, 33134, US

(21) Appl. No.: 12/144,444

(22) Filed: Jun. 23, 2008

Related U.S. Application Data
(63) Continuation-in-part of application No. 12/060,331, filed on Apr. 1, 2008, now abandoned.

(51) Int. Cl. E06C 7/06

(52) U.S. Cl. 182/111

(57) ABSTRACT

A stabilizing mechanism for rigid fixed and extension ladders that includes an anchorage assembly removably mounted to one of the rungs of a ladder. A linkage assembly is mounted to the anchorage assembly and it supports a rigid elongated member that in turn pivotally supports two arched arm members that are selectively locked in place by a locking assembly that can be remotely actuated. The arm members embrace a support member thereby providing a firm engagement of the ladder assembly to the support member. A release mechanism remotely disengages the ladder from the support member once a user descends.

### OTHER RELATED APPLICATIONS

The present application is a continuation-in-part pending of U.S. patent application Ser. No. 12/060,331, filed on Apr. 1, 2008, which is hereby incorporated by reference.

### BACKGROUND OF THE INVENTION

1. Field of the Invention

The present invention relates to rigid fixed and extension ladders, and more particularly, to mechanisms that enhance their stability.

2. Description of the Related Art

Many designs for rigid ladders have been created in the past. However, most of them rely on a stable projection of the gravitational forces over the supporting members of the ladder or adjacent structure to stabilize the ladder. The present invention substantially divorces the ladder from the positions that provide secured engagements thereby expanding their use, specially in applications with limited space. By including a stabilizing mechanism that provides for a stable support that can be remotely activated, the versatility of the ladder is greatly improved.

### SUMMARY OF THE INVENTION

It is one of the main objects of the present invention to provide a mechanism for ladders that provide stability independently of the position of the ladder.

It is another object of this invention to provide a stabilizing mechanism for ladders that can be remotely actuated and released.

It is yet another object of this invention to provide such a mechanism that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an elevational view of a ladder in the upright position using one of the preferred embodiments for the present invention to secure itself against a vertically mounted pole.

FIG. 2 shows an elevational view of the ladder shown in the previous figure with its arm assembly vertically disposed to secure in place the ladder to a structure S such as a tree branch, utility pole, parapet or similar structure.

FIG. 3 illustrates another elevational view where the ladder is positioned over a parapet with the anchorage mechanism that supports the pivoted arm assembly both vertically disposed.

FIG. 4 is an isometric representation of one of the preferred embodiments for the present invention mounted to a ladder shown in phantom. The arm assembly being horizontally disposed.

FIG. 5A is a top view of the preferred embodiment for the present invention disclosed in the previous figures.

FIG. 5B is a side elevational view of the mechanism shown in the previous figure.

FIG. 5C is an isometric representation of the mechanism shown in the previous figures horizontally disposed.

FIG. 5D is similar to the previous figure except that linkage assembly 40 and arm assembly 60 have been rotated to the vertical position.

FIG. 5E is a detail isometric view of clamp or member 24 with a partial representation of housing 20.

FIG. 6 is an enlarged top view of the anchorage and linkage assemblies 20 and 40 with a partial representation of supporting arm assembly 60.

FIG. 7 Is an enlarged cross-sectional view of a portion of the mechanisms shown in FIG. 6, taken along line 7-7. Security pin 51 is shown in the locking (one-way) position.

### DETAILED DESCRIPTION OF THE PREFERRED EMBODIMENT

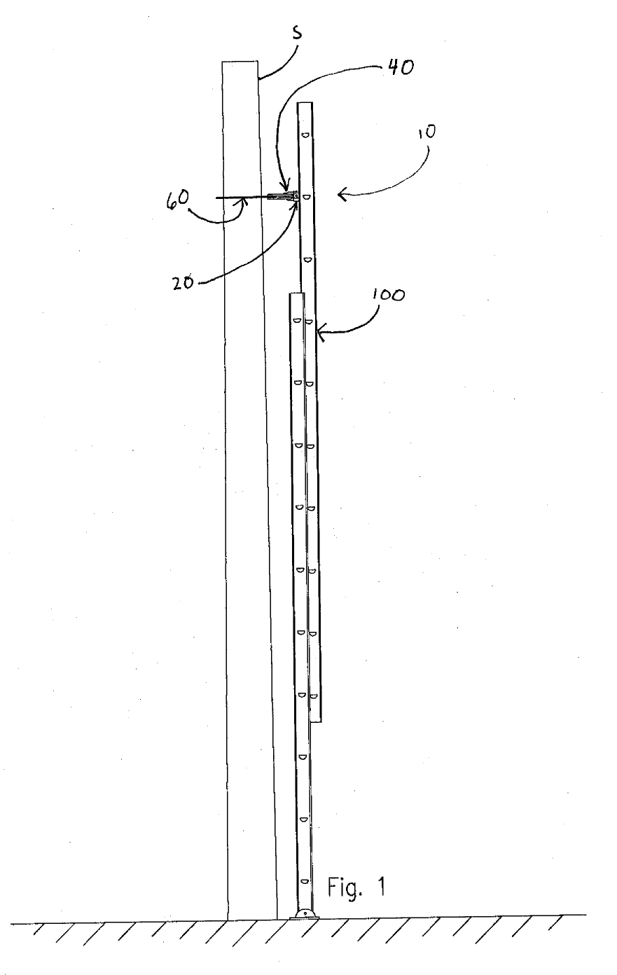

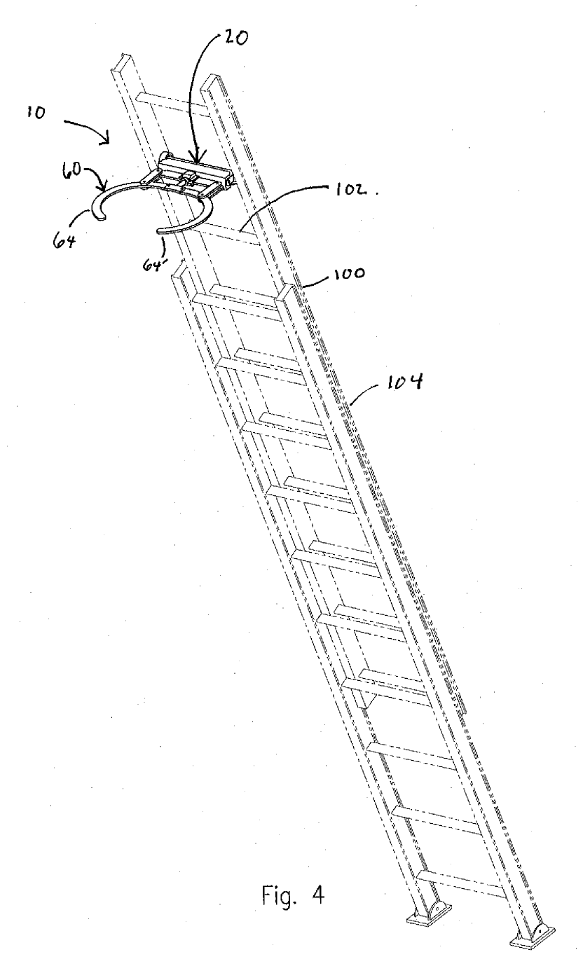

Referring now to the drawings, where the present invention is generally referred to with numeral 10, it can be observed that it basically includes anchorage assembly 20, linkage assembly 40, supporting arm assembly 60 and locking assembly 80, removably mounted to one of the rungs of a ladder 100. Three typical applications are shown in FIGS. 1; 2 and 3 for the use of extension ladder 100 equipped with the present mechanism for fixed structures S. The mounting of mechanism 10 to ladder 100 is shown in FIG. 4 from another angle.

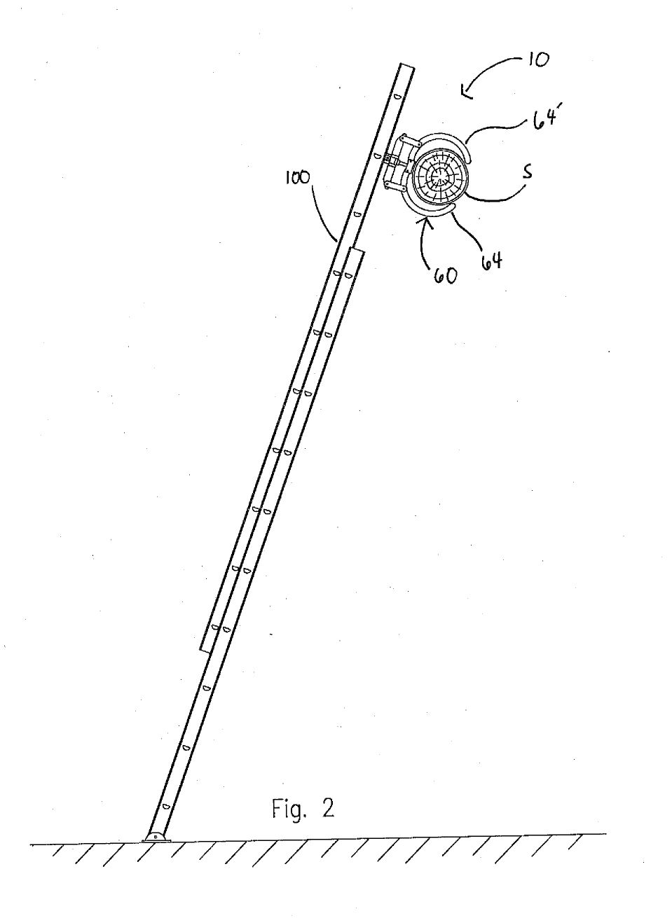

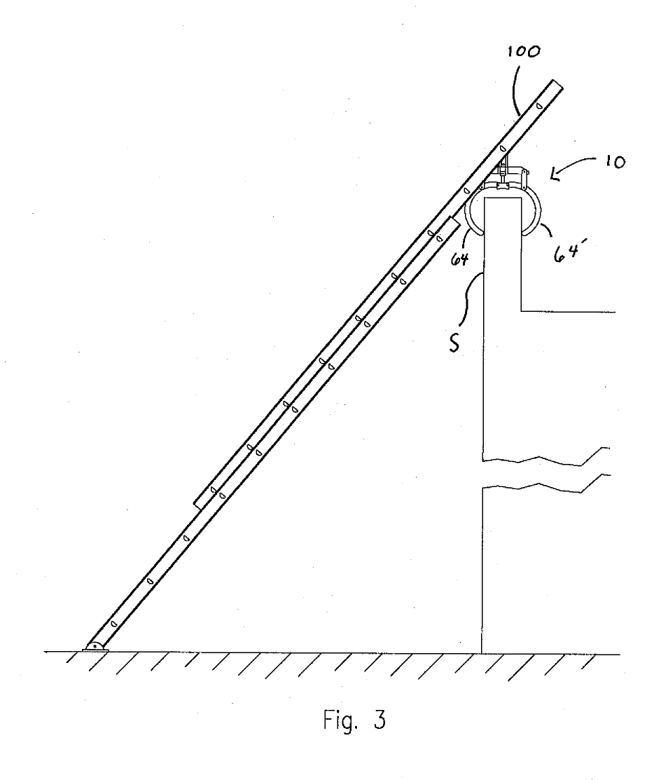

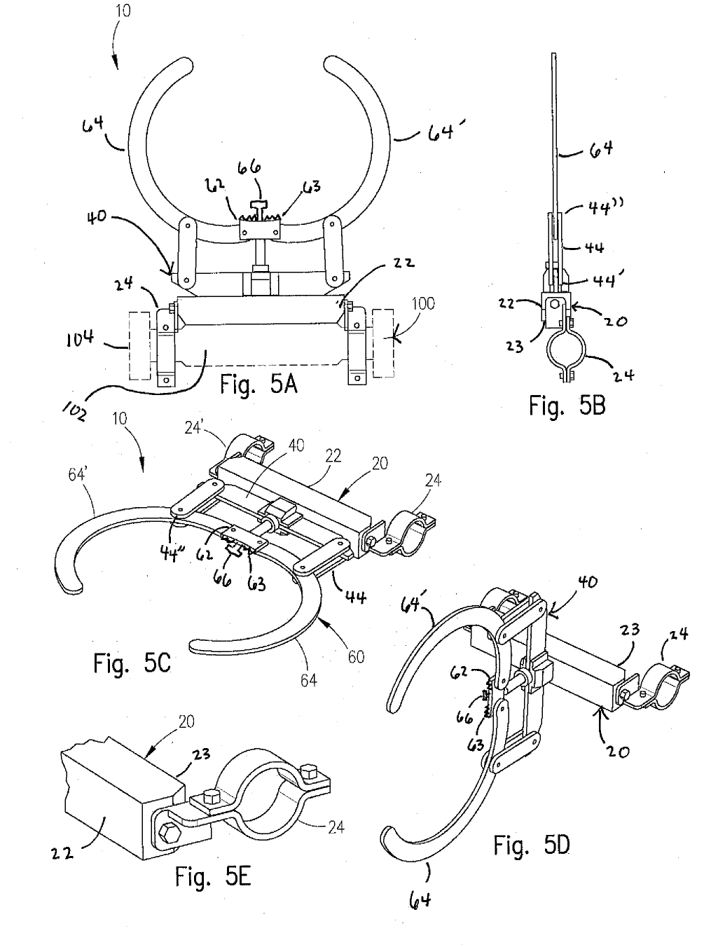

Anchorage assembly 20 includes housing 22 with mounting clamp members 24 and 24′ as best seen in FIGS. 5A; 5B; 5C; 5D and 5E. Housing 22, includes a longitudinal opening 23 that cooperatively receives therethrough rung 102 of ladder 100. Ladder 100 has several spaced apart rungs 102 mounted between beams or stiles 104. Housing 22 partially houses rung 102. Mechanism 10 is mounted, through anchorage assembly 20, at a desired position from one of the ends of ladder 100, as seen in FIGS. 1 through 4. The other end of ladder 100 rests on a supporting, substantially horizontal, surface.

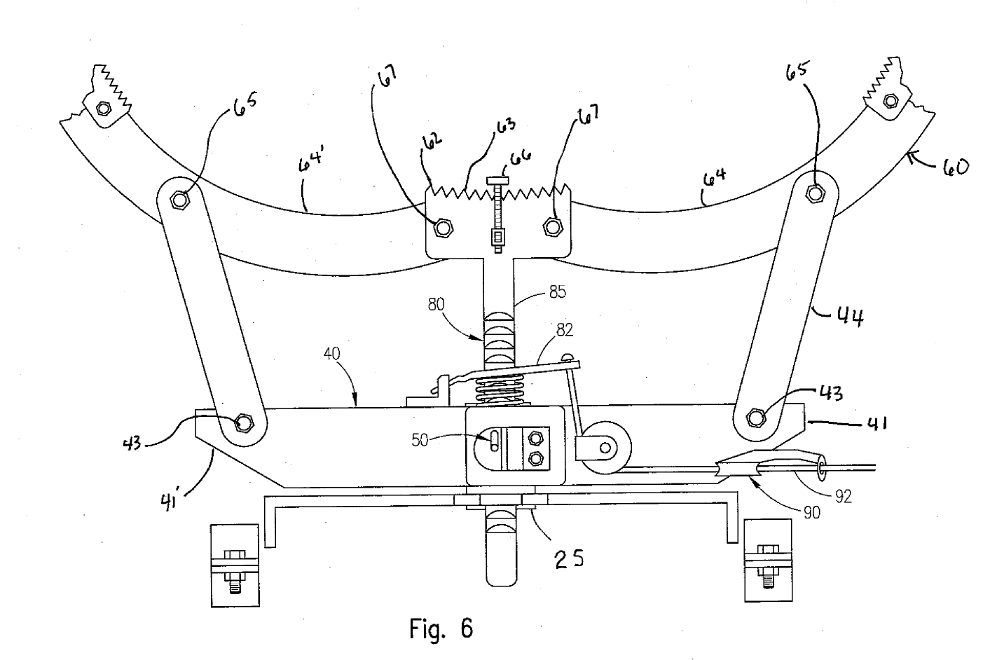

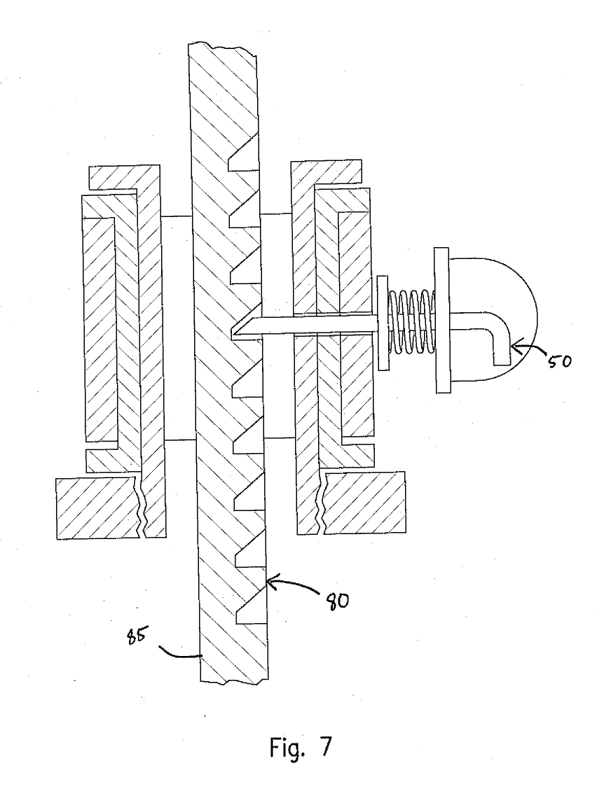

Linkage assembly 40 is rotably mounted to anchorage assembly 20, as best seen in FIGS. 5C, 5D and 6. In one of the preferred embodiments, as the one shown in FIG. 6, bushing assembly 25 rotably receives end 85′ of racheted shaft 85 permitting the rotation of linkage assembly 40 with respect to anchorage assembly 20. Other equivalent mechanisms for rotating assembly 40 at predetermined positions with respect to assembly 20 can be implemented, such as by using a cutter pin (not shown) with a bushing or equivalent. In one of the preferred embodiments, bushing assembly 25 has four positions, at 90 degrees from each other. Linkage assembly 40 extends, in the illustrated preferred embodiment, beyond the length of assembly 20 (and rung 102) with its ends 41 and 41′ providing the necessary pivotal support for linkage arms 44 at pins 43 mounted adjacent to ends 41 and 41′. The other ends 45 are pivotally mounted to supporting arm members 64 and 64′ at pin members 65 next to ends 44″ of linkage arms 44.

Arm assembly 60 includes rigid elongated member 62 that extends parallel to linkage assembly 40, as best seen in FIG. 6. Arm members 64 and 64′ are pivotally mounted to member 62 at a spaced apart predetermined distance where pins 67 are located. In the preferred embodiment, arm members 64 and 64′ are curved and removable so that members 64 and 64′ of different dimensions can be used. Pivoting pins 43; 65 and 67 coact to permit arms 64 and 64′ to move in and out between two extreme positions. The movement is originated by causing member 62 to move, such as by bringing member 62 against a fixed structure S. Member 62 is provided with serrations 63 for former grip against structure S.

Locking assembly 80 is centrally mounted on linkage assembly 40 and includes release lever 82 positioned between the pivoting points of link members 44 and 44′, as best seen in FIG. 6. A user moves the upper end of ladder 100 towards a support member S such as a pole, branch or parapet, as shown in FIGS. 1 through 3. A force of predetermined magnitude exerted against actuator 66 causes arm members 64 and 64′ to move towards each other embracing the targeted support member S. Locking assembly 80 is connected to release assembly 90 that can be actuated remotely, from the other end of ladder 100. In one of the preferred embodiments, a cord 92 is used to pull the release lever 82 that liberates ratcheted shank 85 of locking assembly 80.

In operation, a user brings one end against the support member S, bitting it with sufficient force to activate actuator 66 thereby causing aim members 64 and 64′ to embrace support member S. This provides a stable connection between the upper end of ladder 100 and support member S. A user then shakes ladder 100 to ensure a firm engagement before climbing. After descending, a user then remotely actuates release lever 82 through release assembly 90, releasing the engagement.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A stabilizing mechanism for rigid fixed and extension ladders, comprising:
A) a ladder assembly with first and second ends, and having two beams with a plurality of rungs mounted thereinbetween;
B) anchorage means removably mounted to one of said rungs;
C) a linkage assembly having third and fourth ends, said linkage assembly being mounted ratably to said anchorage means and further including first and second linkage with fifth and sixth ends each pivotally mounted to said third and fourth ends respectively, at said fifth end;
D) an arm assembly having a rigid elongated member extending parallel to said linkage assembly and kept at a spaced apart relationship and including a ratcheted shank with seventh and eighth ends, said seventh end being rigidly mounted to said rigid elongated member and said eighth end being ratably mounted to said linkage assembly, first and second arched arm members pivotally mounted to said support member at a predetermined distance from each other and coplanarly cooperatively disposed to move between two extreme positions; and
E) locking means for keeping said arm members at predetermined positions cooperatively embracing a support member thereby providing a firm engagement of said ladder assembly to said support member.
